(19) United States
(12) Patent Application Publication
(10) Pub. No.: US 2026/0061316 A1
(43) Pub. Date: Mar. 5, 2026

(54) MOTION VECTORS REPRESENTING TRANSFORMATIONS IN GEOMETRY IN SCENES TO BE RENDERED BY AN APPARATUS

(71) Applicant: HUAWEI TECHNOLOGIES CO., LTD., Shenzhen (CN)

(72) Inventors: Benjamin Mitchell, Cambridge (GB); Lai Wei, Cambridge (GB); Arnau Raventos, Cambridge (GB); Senling Lin, Shenzhen (CN); Theo William Jonchier, London (GB); Richard Huddy, Cambridge (GB)

(73) Assignee: HUAWEI TECHNOLOGIES CO., LTD., Shenzhen (CN)

(21) Appl. No.: 19/382,195

(22) Filed: Nov. 6, 2025

Related U.S. Application Data
(63) Continuation of application No. PCT/EP2023/063157, filed on May 16, 2023.

(51) Int. Cl. A63F 13/525; G06T 15/10

(52) U.S. Cl. CPC A63F 13/525; G06T 15/10

(57) ABSTRACT

An apparatus to generate a first vertex output representing a vertex stream comprising a first list of vertices for opaque objects of a first frame of the scene, generate a first set of hash values using data associated with the first list of vertices for opaque objects of the first frame of the scene, generate a second vertex output representing a vertex stream comprising a second list of vertices for opaque objects of a second frame of the scene, generate a second set of hash values using data associated with the second list of vertices for opaque objects of the second frame of the scene, match opaque objects of the first frame of the scene with opaque objects of the second frame of the scene using the first set of hash values and the second set of hash values, and execute a render operation using the transformed vertex outputs.

### CROSS-REFERENCE TO RELATED APPLICATIONS

This application is a continuation of International Application No. PCT/EP2023/063157, filed on May 16, 2023, the disclosure of which is hereby incorporated by reference in its entirety.

### TECHNICAL FIELD

Embodiments of the present disclosure relate, in general, to generation of motion vectors representing a transformation in geometry in a scene to be rendered. Aspects relate to application agnostic generation of motion vectors.

### BACKGROUND

Requirements for real-time rendering are increasing at a dramatic rate, as more and more computing power is required to render the complexity and realism expected in modern games. Mobile devices in particular are struggling to meet this requirement, as they have significantly less raw computer power than their desktop counterparts. In order to meet this requirement, methods of adding detail to real-time games applications without directly rendering the content are being investigated, including super-resolution scaling, variable rate shading (VRS), and frame interpolation/extrapolation. Every one of these solutions require a common input; motion vectors (MVs). Motion vectors are becoming a critical part of games' render pipelines, particularly with modern hardware developers investigating efficient rendering methods to re-use already rendered pixels.

Within the concept of a game engine, which provides a framework within which a game can be developed and/or in which frames of a game can be rendered by hardware, motion vectors are trivial to generate. The game engine has knowledge of what an object is, so the engine can know if an object is, e.g., the player, or if an object is, e.g., a specific rock within a scene. Engines generally submit application programming interface (API) draw-calls as part of an “object” class, so low-level draw calls are intrinsically tied to the game objects they represent. The engine can therefore know for any given frame what the rock's current world position is, and what the world position of that rock was in previous frames. Hence the engine can generate a motion vector representing a motion for the rock in any fashion it decides to. This is typically done by performing an MV render pass containing draw calls with both the object's current MV prediction (MVP) and previous MVP accessible via shader uniform values. The output MV is then just an interpolation between the current and previous transformed positions generated by multiplying the MVP matrices with the object space vertices.

Game engines are also able to make some optimizations to the generation of motion vectors, as the engine can distinguish between static and dynamic objects. For dynamic objects, individual motion must be generated for each object. This is often done per-vertex to allow for handling of animated meshes. However, for objects the engine knows to be static, the motion can be inferred per-pixel from its depth and the difference in the player's camera state between the two frames.

However, in general, extensive collaboration with game or game engine developers involved in the production of a game application is required in order to provide the kind of optimisations described above. For example, developers must integrate certain solutions into their game engines, and make sure that motion vectors are calculated for the current frame at an earlier point in the pipeline than they otherwise would be normally. Requiring game engine modifications to integrate hardware developers' optimization algorithms is over-complex and non-scalable.

### SUMMARY

Embodiments of of the present disclosure provide methods for generating MVs in real-time such that a graphics processing unit driver can use the MVs to add detail to a rendered result of the GPU's work without sacrificing more performance than would be saved when compared to just rendering the additional detail. Aspects enable MVs to be used for frame extrapolation.

A first aspect of the present disclosure provides an apparatus for generating a set of motion vectors representing a transformation in geometry in a scene to be rendered by the apparatus, the apparatus comprising a processor, a memory coupled to the processor, the memory configured to store program code executable by the processor, the program code comprising one or more instructions, whereby to cause the apparatus to generate a first vertex output representing a vertex stream comprising a first list of vertices for opaque objects of a first frame of the scene, wherein the first list of vertices for opaque objects of the first frame of the scene is arranged according to an order of drawing commands submitted in respect of the opaque objects of the first frame of the scene, generate a first set of hash values using data associated with the first list of vertices for opaque objects of the first frame of the scene, generate a second vertex output representing a vertex stream comprising a second list of vertices for opaque objects of a second frame of the scene, wherein the second frame of the scene is adjacent to the first frame of the scene, and wherein the second list of vertices for opaque objects of the second frame of the scene is arranged according to an order of drawing commands submitted in respect of the opaque objects of the second frame of the scene, generate a second set of hash values using data associated with the second list of vertices for opaque objects of the second frame of the scene, match opaque objects of the first frame of the scene with opaque objects of the second frame of the scene using the first set of hash values and the second set of hash values, whereby to determine transformed vertex outputs representing corresponding objects from the first frame of the scene and the second frame of the scene, and execute a render operation using the transformed vertex outputs, whereby to generate a set of motion vectors for the scene representing a transformation between the geometry of the opaque objects of the first frame of the scene and the geometry of the opaque objects of the second frame of the scene.

Accordingly, motion vector data is made accessible at a lower level than an, e.g., game engine. As motion vectors are such a critical part of games' render pipelines, particularly with modern hardware developers investigating efficient rendering methods to re-use already rendered pixels, providing access to this data in an application agnostic manner enables driver level integration thereby enabling efficient motion vector generation and subsequent usage in efficient rendering algorithms such as frame interpolation/extrapolation, variable rate shading and image upscaling for example.

In an implementation of the first aspect, the program code can comprise one or more instructions, whereby to cause the apparatus to determine a set of identical hash values occurring between the first set of hash values and the second set of hash values, and for each opaque object represented by one of the hash values in the set of identical hash values, minimise a measure of total geometric distance between estimated projections for vertices of an opaque object from each of the first frame of the scene and the second frame of the scene and actual projections for vertices of the opaque object from each of the first frame of the scene and the second frame of the scene.

The program code can comprise one or more instructions, whereby to cause the apparatus to execute a render operation using the transformed vertex outputs by executing a draw call for objects from the first frame of the scene and the second frame of the scene. The program code can comprise one or more instructions, whereby to cause the apparatus to enable a transform feedback buffer to store a post-transformation rendering state for an opaque object, wherein a post-transformation rendering state for an opaque object of the first frame of the scene comprises the first list of vertices, and wherein a post-transformation rendering state for an opaque object of the second frame of the scene comprises the second list of vertices. The program code can comprise one or more instructions, whereby to cause the apparatus to use the set of motion vectors for the scene to interpolate and/or extrapolate vertex information for one or more opaque objects of the scene, whereby to generate a third frame of the scene comprising a frame intermediate to the first frame of the scene and the second frame of the scene and/or a frame before and/or after the first frame of the scene and/or the second frame of the screen.

A second aspect of the present disclosure provides a machine-readable storage medium encoded with instructions for generating a set of motion vectors representing a transformation in geometry in a scene to be rendered by an apparatus, the instructions executable by a processor, whereby to cause the processor to generate a first vertex output representing a vertex stream comprising a first list of vertices for opaque objects of a first frame of the scene, wherein the first list of vertices for opaque objects of the first frame of the scene is arranged according to an order of drawing commands submitted in respect of the opaque objects of the first frame of the scene, generate a first set of hash values using data associated with the first list of vertices for opaque objects of the first frame of the scene, generate a second vertex output representing a vertex stream comprising a second list of vertices for opaque objects of a second frame of the scene, wherein the second frame of the scene is adjacent to the first frame of the scene, and wherein the second list of vertices for opaque objects of the second frame of the scene is arranged according to an order of drawing commands submitted in respect of the opaque objects of the second frame of the scene, generate a second set of hash values using data associated with the second list of vertices for opaque objects of the second frame of the scene, match opaque objects of the first frame of the scene with opaque objects of the second frame of the scene using the first set of hash values and the second set of hash values, whereby to determine transformed vertex outputs representing corresponding objects from the first frame of the scene and the second frame of the scene, and execute a render operation using the transformed vertex outputs, whereby to generate a set of motion vectors for the scene representing a transformation in the geometry of the opaque objects of the first frame of the scene with the geometry of the opaque objects of the second frame of the scene.

In an implementation of the second aspect, the machine-readable storage medium can further comprising instructions executable by the processor, whereby to cause the processor to determine a set of identical hash values occurring between the first set of hash values and the second set of hash values, and for each opaque object represented by one of the hash values in the set of identical hash values, minimise a measure of total geometric distance between estimated projections for vertices of the opaque object from each of the first frame of the scene and the second frame of the scene, and actual projections for vertices of the opaque object from each of the first frame of the scene and the second frame of the scene. The machine-readable storage medium can further comprise instructions executable by the processor, whereby to cause the processor to execute a render operation using the transformed vertex outputs by executing a draw call for objects from the first frame of the scene and the second frame of the scene. The machine-readable storage medium can further comprising instructions executable by the processor, whereby to cause the processor to enable a transform feedback buffer to store a post-transformation rendering state for an opaque object, wherein a post-transformation rendering state for an opaque object of the first frame of the scene comprises the first list of vertices, and wherein a post-transformation rendering state for an opaque object of the second frame of the scene comprises the second list of vertices. The machine-readable storage medium can further comprising instructions executable by the processor, whereby to cause the processor to use the set of motion vectors for the scene to interpolate and/or extrapolate vertex information for one or more opaque objects of the scene, whereby to generate a third frame of the scene comprising a frame intermediate to the first frame of the scene and the second frame of the scene and/or a frame before and/or after the first frame of the scene and/or the second frame of the screen.

A third aspect of the present disclosure provides a method for generating a set of motion vectors representing a transformation in geometry in a scene to be rendered, the method comprising generating a first vertex output representing a vertex stream comprising a first list of vertices for opaque objects of a first frame of the scene, wherein the first list of vertices for opaque objects of the first frame of the scene is arranged according to an order of drawing commands submitted in respect of the opaque objects of the first frame of the scene, generating a first set of hash values using data associated with the first list of vertices for opaque objects of the first frame of the scene, generating a second vertex output representing a vertex stream comprising a second list of vertices for opaque objects of a second frame of the scene, wherein the second frame of the scene is adjacent to the first frame of the scene, and wherein the second list of vertices for opaque objects of the second frame of the scene is arranged according to an order of drawing commands submitted in respect of the opaque objects of the second frame of the scene, generating a second set of hash values using data associated with the second list of vertices for opaque objects of the second frame of the scene, matching opaque objects of the first frame of the scene with opaque objects of the second frame of the scene using the first set of hash values and the second set of hash values, whereby to determine transformed vertex outputs representing corresponding objects from the first frame of the scene and the second frame of the scene, and executing a render operation using the transformed vertex outputs, whereby to generate a set of motion vectors for the scene representing a transformation in the geometry of the opaque objects of the first frame of the scene with the geometry of the opaque objects of the second frame of the scene.

In an implementation of the third aspect, the method can further comprise determining a set of identical hash values occurring between the first set of hash values and the second set of hash values, and for each opaque object represented by one of the hash values in the set of identical hash values, minimising a measure of total geometric distance between estimated projections for vertices of the opaque object from each of the first frame of the scene and the second frame of the scene, and actual projections for vertices of the opaque object from each of the first frame of the scene and the second frame of the scene. The method can further comprise executing a render operation using the transformed vertex outputs by executing a draw call for objects from the first frame of the scene and the second frame of the scene. The method can further comprise enabling a transform feedback buffer to store a post-transformation rendering state for an opaque object, wherein a post-transformation rendering state for an opaque object of the first frame of the scene comprises the first list of vertices, and

wherein a post-transformation rendering state for an opaque object of the second frame of the scene comprises the second list of vertices. The method can further comprise using the set of motion vectors for the scene, interpolating and/or extrapolating vertex information for one or more opaque objects of the scene, whereby to generate a third frame of the scene comprising a frame intermediate to the first frame of the scene and the second frame of the scene and/or a frame before and/or after the first frame of the scene and/or the second frame of the screen.

These and other aspects of the invention will be apparent from the embodiment(s) described below.

### BRIEF DESCRIPTION OF THE DRAWINGS

In order that the present disclosure may be more readily understood, embodiments will now be described, by way of example, with reference to the accompanying drawings, in which:

FIG. 1 is a schematic representation of 1-dimensional cost matrix for determining a distance between points in a first frame to points in second frame, according to an embodiment of the present disclosure;

FIG. 2 is a schematic representation of the 1-dimensional cost matrix of FIG. 1 once the cells have been sorted, according to an embodiment of the present disclosure;

FIG. 3 is a schematic representation of the 1-dimensional cost matrix of FIG. 2 in which chosen cells are highlighted, according to an embodiment of the present disclosure;

FIG. 4 is schematic representation of the 1-dimensional cost matrix of FIG. 3 in which existing matches are swapped for matches that provide a lower distance, according to an embodiment of the present disclosure;

FIG. 5 is schematic representation of the 1-dimensional cost matrix of FIG. 4 with accepted matches, according to an embodiment of the present disclosure;

FIG. 6 is a schematic representation of a machine according to an embodiment of the present disclosure; and

FIG. 7 is a flow chart of a method, according to an embodiment of the present disclosure.

### DETAILED DESCRIPTION

Embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

The following contains information related to implementations of the present disclosure. The drawings and their accompanying detailed disclosure are merely directed to implementations. However, the present disclosure is not limited to these implementations. Other variations and implementations of the present disclosure will be obvious to those skilled in the art.

The phrases “in one implementation,” or “in some implementations,” may each refer to one or more of the same or different implementations. The term “coupled” is defined as connected whether directly or indirectly through intervening components and is not necessarily limited to physical connections. The expression “at least one of A, B and C” or “at least one of the following: A, B and C” means “only A, or only B, or only C, or any combination of A, B and C.”

The terms “system” and “network” may be used interchangeably.

For the purposes of explanation and non-limitation, details such as functional entities, techniques, protocols, and standards are set forth for providing an understanding of the present disclosure. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software or a combination of software and hardware. Disclosed functions may correspond to modules which may be software, hardware, firmware, or any combination thereof.

A software implementation may include machine- and/or computer-readable and/or executable instructions stored on a machine- and/or computer-readable medium such as memory or other types of storage devices. One or more microprocessors or general-purpose computers with communication processing capability may be programmed with corresponding executable instructions and perform the disclosed network function(s) or algorithm(s).

The microprocessors or general-purpose computers may include Applications Specific Integrated Circuitry (ASIC), programmable logic arrays, and/or using one or more Digital Signal Processor (DSPs). Although some of the disclosed implementations are oriented to software installed and executing on computer hardware, alternative implementations implemented as firmware or as hardware or as a combination of hardware and software are well within the scope of the present disclosure. The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

Gathering low-level, general use motion vectors is generally very difficult to do efficiently, especially when compared to game engines that have access to knowledge that makes MV generation trivial.

According to an example, driver level integration of efficient Motion Vector generation is provided along with subsequent usage in efficient rendering algorithms such as frame interpolation/extrapolation, variable rate shading and image upscaling. That is, according to an example, motion vectors are made accessible at a lower level than a game engine. For example, motion vectors are made accessible in a graphics processing unit (GPU) driver. Accordingly, there is no longer access to information defining the relationship between GPU draw calls and the object they resemble. The draw calls are now simply obfuscated GPU commands. Therefore, a method of generating MVs at that lower level is provided, in which the generated MVs can be used to add detail, such as by generating additional frames, to applications in real-time without game engine modification.

According to an example, GPU features are utilised to gain access to post-transformation vertex information for an object or objects. This information is gathered and used at a level lower than the graphics API, meaning this information is gathered in a game-agnostic, portable fashion. In an example, a GPU extension, such as transform feedback (XFB), can be used to gather the positions of all vertices in a scene after transformation has occurred in the application's opaque pass' vertex shader. Once two frames have passed and both frames have stored a list of all transformed geometry in the scene, draw call matching is performed to match up groups of vertices from the two lists that belong to a given object's draw. A given object may be, for example, a specific rock in the application's 3D scene. Draw call matching provides an indication of where to look in the previous frame (N−1)'s XFB buffer for the transformed geometry describing the rock's previous position. It then also provides an indication of where to look in the current frame (N)'s XFB buffer for the transformed geometry describing the rock's current position.

With both of these positions for a given draw available, a separate MV render pass is submitted, where each new draw uses the previous and current positions saved as per-vertex inputs. In an example, a motion vector calculation itself can be provided by the vector difference between the two positions for given vertices, using standard GPU technology to interpolate across the fragments this geometry covers. The output is therefore a two-dimensional texture containing MV values, of the same dimensions as the initial opaque pass render.

Motion Vectors generated as described above can be used to:
Interpolate between two previously rendered frames. Henceforth referred to as game frame interpolation (GFI); and/or
Extrapolate a new frame by offsetting a single, previously rendered frame. Henceforth referred to as game frame extrapolation (GFE).

For example, MVs can be generated by interpolating/extrapolating vXFB positions, then using fragment-level MVs to offset a rendered image of the previous frame.

According to an example, a method of solving the inherent problems of extrapolating new frames is provided using a motion vector by infilling missing regions. Infilling is focused on efficiency as the target platform can be, e.g., a mobile device such as a smart phone where computational power is limited.

As noted above, Transform Feedback (XFB) can be used to gather the positions of all vertices in a scene after transformation has occurred in the application's opaque pass' vertex shader. XFB is supported on most devices and in most graphics' APIs. The purpose of XFB is to allow access to the results of the final vertex-processing step enabled in the graphics pipeline. If tessellation or geometry shading steps are enabled, XFB will capture the output of these stages. If neither tessellation nor geometry shading is enabled, the results of the vertex shading step is recorded.

XFB records information serially, meaning that the XFB output is ordered based on the draw call submission order, with the earliest submitted draw call being recorded first. XFB outputs all transformed vertices submitted by a draw, regardless of whether they were culled by the GPU during rendering. Hence the bandwidth cost of XFB can be quite high. However, according to an example, the implicit ordering and lack of culling enables position outputs from the graphics API to be tracked. That is, when a draw call is submitted, the position it will occupy in the final XFB buffer can be immediately recorded, since all draws that have been submitted thus far for this pass are already known, as is exactly how large each draw-call's output will be in the buffer. This enables determination of exact XFB outputs for each draw in hand and therefore it can be decided for which draw call submissions XFB should be enabled.

According to an example, there is no interest in full-screen render passes performed for post-processing etc. Furthermore, any alpha-blended draw-calls are also not of interest. That is, to generate a single layer, per-pixel, of MV information, alpha-blended geometry cannot be tracked on top of the opaque geometry behind it. Therefore, in an example, the only desirable draw-call submissions are those contained in the application's opaque rendering pass(es). That is, those relating to opaque objects of a scene. One or more metrics can be provided for determining which render passes and draws are for opaque rendering. For example, draws whose graphics pipeline dictates that the draw will not enable the GPU's alpha blending units, and will also enable depth rendering on top of at least one output colour buffer can indicate render passes and draws are for opaque rendering. This therefore eliminates all alpha-blended geometry, full-screen static draws (post-processing passes) and any additional small passes for rendering, e.g., off-screen textures. A more specific filter can be used to avoid passes that render to specific formats that may contain intermediate textures, rendered with a similar format to the opaque pass, such as MVs, visibility buffers etc. Following a second frame being rendered, two buffers of transformed opaque geometry, one for each rendered frame, are therefore available.

According to an example, in order to generate MVs, new draw calls can be submitted for each object that was present in both of a first frame in a scene to be rendered and a second (e.g., subsequent) frame in a scene to be rendered. The XFB output specific to that object from both frames can be used as input data for generating a set of MVs representing a transformation in geometry of the object.

However, XFB buffers of transformed opaque geometry may not be of the same length, or even in the same order. That is, draw calls are commonly re-ordered between frames by game applications for more efficient processing by GPUs. Draw calls are also often added or removed between frames, with, e.g., new objects coming into the frame, or objects moving outside the camera's view space. Therefore, a draw call's XFB offset from a first frame (e.g., frame N−1) must be matched to a draw call's offset from a second frame (e.g., frame N), where both offsets point to transformed vertex output relevant to the same game object, from two different frames.

According to an example, to match draw calls, a hash value is generated for each draw call submitted. The hash can be generated from one or more of multiple values associated with the draw, such as for example:
Bound descriptor set data.
Bound vertex buffer.
Bound index buffer.
Bound Vulkan pipeline settings.
Bound Shader source.
Draw index/vertex count

Two draws, one from each of the first and second frames, with associated XFB offsets are then considered to be a match if they have a matching hash value. Hash values can be used to match the majority of draw calls in a scene. However, for a complex scene, hash matching may only cover around 80% of the opaque draw matching for a given frame. Outliers exist firstly when multiple identical draw calls are submitted in a frame, giving multiple draws to map to the same hash value. Secondly, when instanced rendering is done, in which case there are instance_count instances all sharing the same hash value. Instances may be re-ordered, and the number of instances for a draw is often changed between frames as the camera moves, so these must also be matched. In both cases, the result is A elements in frame N−1 and B elements in frame N all sharing the same hash value, so it is no longer a one-to-one mapping. Therefore, a mechanism to map between draws that share a hash value can be provided.

Since all values contributing to a hash are identical, the only differentiating factor available between draws are their transformed positions. Accordingly, a heuristic-based matching can be used in an example to match, for each hash with more than a single element per frame, each element of A to the most reasonable (distance-wise) element of B. However, two elements in A may both choose the same element in B, or choosing one element of B may force another element in A to delegate itself to a particularly poor choice in B, since it cannot have the element of B that is its best choice. A similar issue occurs in the field of optimal transport. The optimal mapping from one set to the other is defined as finding the combination of matches that has the lowest total distance value, where the total distance value is acquired by summing the distance between each point and its matched point in the other set. However, in the scope of distance matching for MV generation, an objective is to generate MVs at a low enough cost to be used to save overall rendering cost, and thus efficiency must be prioritised over accuracy. Accordingly, execution of an entire distance matching algorithm must take place within a few milliseconds, meaning that industry-standard solutions to Optimal Transport are not suitable as their cost is too high. According to an example, a homography matrix can be used to improve accuracy for generic motion.

The motion of drawcalls is initially predicted in order to provide a better estimate as to where frame N draws will land in frame N+1. The new predicted points can then be matched with the actual points in frame N+1. In an example, predicting positions can be performed by determining a matrix that transforms vertices of objects in frame N to the vertices of those objects in frame N+1. Such a transformation matrix is referred to as a Homography matrix as it is based on a similar concept to camera estimation from feature points on a flat plane in computer vision.

According to an example, given P, a point in frame N, P′, a point in frame N+1, and the homography matrix M, the transformation of the point is written:

$${P}^{′} = M * P$$

Those two vertices can be obtained directly from the XFB buffer. Taking the vertices from the offsets of a known 1:1 match guarantees the vertices share the same initial point, but transformed in its respective frame clip-space coordinates.

The matrix M can be decomposed in 4 rows R_{0 . . . 3}, each composed of 4 components (x, y, z and w):

$$M = ( \begin{matrix}Ro \\ {R}_{1} \\ {R}_{2} \\ {R}_{3}\end{matrix} )$$

Using a 1:1 match obtained from draw call matching, four transformed points from the previous and the next frame can be extracted from the transform feedback buffer. Those points can be denoted P₀ to P₃ for frame N and P′₀ to P′₃ for the points belonging to frame N+1. Accordingly:

$${R}_{0} = {( \begin{matrix}{p}_{0} \\ {p}_{1} \\ {p}_{2} \\ {p}_{3}\end{matrix} )}^{- 1} * [ \begin{matrix}{P}_{0}^{′} \cdot x & {P}_{1}^{′} \cdot x & {P}_{2}^{′} \cdot x & {P}_{3}^{′} \cdot x\end{matrix} ]$$

$${R}_{1} = {( \begin{matrix}{p}_{0} \\ {p}_{1} \\ {p}_{2} \\ {p}_{3}\end{matrix} )}^{- 1} * [ \begin{matrix}{P}_{0}^{′} \cdot y & {P}_{1}^{′} \cdot y & {P}_{2}^{′} \cdot y & {P}_{3}^{′} \cdot y\end{matrix} ]$$

$${R}_{2} = {( \begin{matrix}{p}_{0} \\ {p}_{1} \\ {p}_{2} \\ {p}_{3}\end{matrix} )}^{- 1} * [ \begin{matrix}{P}_{0}^{′} \cdot z & {P}_{1}^{′} \cdot z & {P}_{2}^{′} \cdot z & {P}_{3}^{′} \cdot z\end{matrix} ]$$

$${R}_{3} = {( \begin{matrix}{p}_{0} \\ {p}_{1} \\ {p}_{2} \\ {p}_{3}\end{matrix} )}^{- 1} * [ \begin{matrix}{P}_{0}^{′} \cdot w & {P}_{1}^{′} \cdot w & {P}_{2}^{′} \cdot w & {P}_{3}^{′} \cdot w\end{matrix} ]$$

This mechanism functions providing that points are not co-planar and that they belong to a static piece of geometry. Checking co-planarity is trivial in itself but finding static objects without game-engine level information is non-trivial as it requires shader/pipeline analysis to understand how vertices are transformed during a vertex shading pass.

According to an example, in order to overcome this, the homography matrix for multiple 1:1 matched objects can be calculated. An error value can be obtained for any matrix by computing the mean squared error with all other matrices obtained that way. The matrix that minimizes that error value is most likely computed from static geometry. In practice this works well with as little as 5 to 8 hash matched drawcalls to compute the transformation matrix. However, it does not solve the matching of overlapping hashes on its own because of floating point imprecision and dynamic objects. Indeed, some of the floating-point precision has already been lost during the vertex transformation to clip space. As a result, the homography matrix is not always exact, and even for static object there might be small numerical errors during the reprojection.

Additionally, dynamic objects (moving objects, animated characters or grass for example) add some additional motion that is not tied to the camera motion. Therefore, their velocity is tracked individually to get a better indication of where they are moving, not relative to the camera. Offsetting this velocity each frame using the homography matrix gives a good estimate of how far a dynamic object moved from the camera motion described by the homography matrix. This enables a prediction for the motion of dynamic objects. In an example, the homography matrix is used as a first, good quality estimate for position prediction to increase the quality of a distance matching algorithm.

Using the homography matrix and velocity prediction described above it is now possible to have an estimate of the projection of a vertex from frame N to frame N+1. The target here is to take as input a set of predicted positions for frame N to N+1, a set of actual positions for frame N+1, and find a set of matches between the two that minimizes the total distance sum of all matches chosen. According to an example, a distance matching method uses a cost matrix.

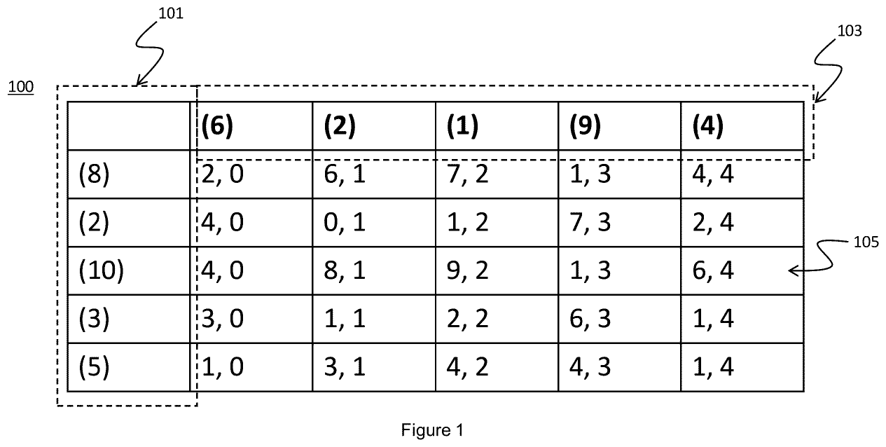

FIG. 1 is a schematic representation of a cost matrix according to an example. The cost matrix 100 determines the distance between all points in frame N to all points in frame N+1. The example of FIG. 1 is a simplified, 1-dimensional example of a cost matrix. Numbers in column 101 are positions in frame N (A), and the numbers in the row 103 are positions in frame N+1 (B). Each cell (X, Y) (e.g., 105) contains:

$$distance : Ax to By , y \}$$

The value y is used later to index back to which column the distance value was calculated from, for this row.

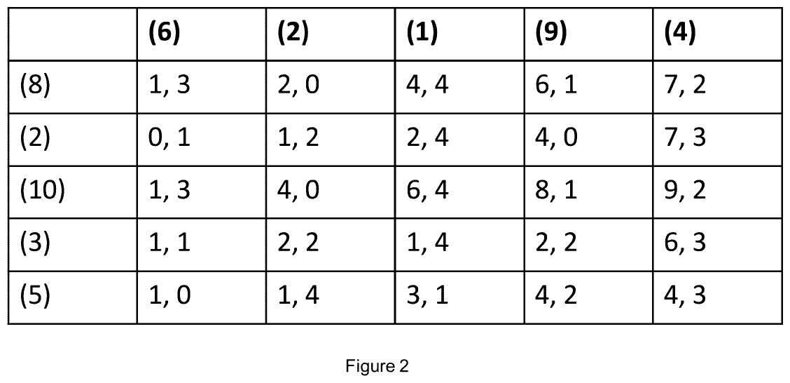

FIG. 2 is a schematic representation of a cost matrix according to an example. The cost matrix of FIG. 2 is the result of sorting the cost matrix 100 of FIG. 1 by distance (the first element of the pair in each cell), so that the closest column to each row is placed in that row's 0^{th} position.

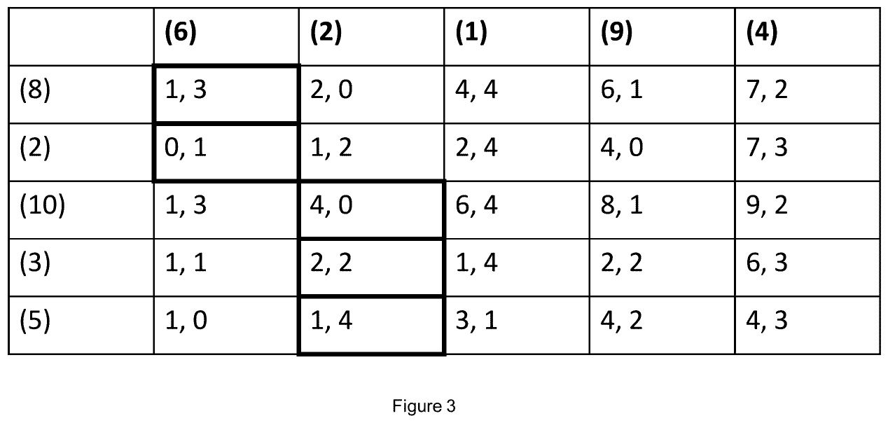

FIG. 3 is a schematic representation of a cost matrix according to an example. In the example of FIG. 3 rows, starting from row 0, attempt to take their first (closest) column. If that column is already taken (as on row 2, position value {10}, where column 3 is already taken by row 0), the row will step down through the available columns until it finds one that is available. Accordingly, rows try to claim their first match (x=0). If it already taken, they increment x and retry until they find a match. Rows chosen cells are highlighted in bold. In a perfect, easy scenario, each row would be able to take its first available column. This perfect scenario happens more often thanks to the Homography Matrix Estimation method.

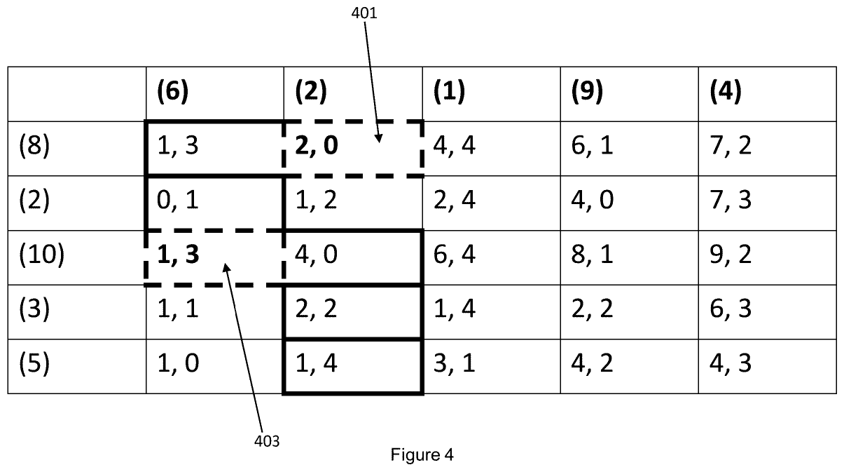

FIG. 4 is a schematic representation of a cost matrix according to an example. In the example of FIG. 4 rows will try to improve their current match. This is done iteratively, starting at row 0. If the row has its best match already, the iteration continues. If the row does not have its best match already, it will attempt to swap its current column with the row that has the column it wants. The new match will be accepted if the distance sum of the new match is lesser than the distance sum of the old match. This process can continue, looping through the entire matrix until it does a full iteration of the matrix without any swaps taking place, at which point it exits the loop.

For example, with reference to cells 401 and 403, which are highlighted with dashed lines, if a new match has lower total distance, a swap is made, and so in this case determine whether (2+1)> (4+1). If not, the swap is made.

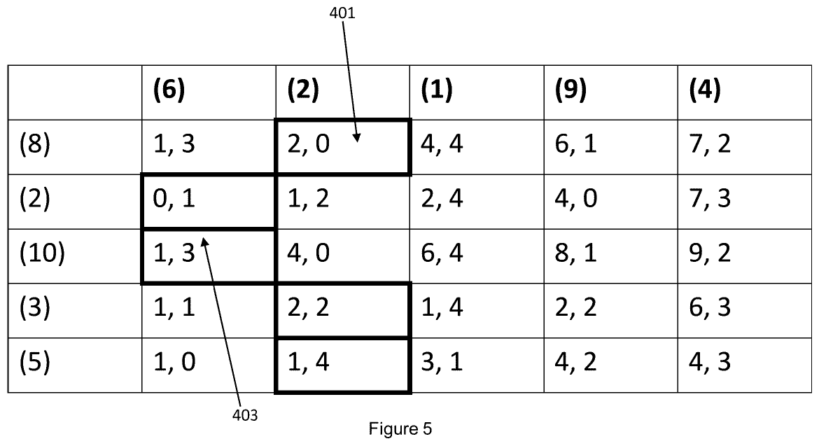

FIG. 5 is a schematic representation of a cost matrix according to an example. In the example of FIG. 5 the cells highlighted with darker borders represent the final matches. The second value in each cell is the original column that the distance value came from and can be used to describe the final matches. For example, Row 0 matched with (2, 0), i.e., column 0 with a distance of 2. The offsets stored at draw submission time for these row/column matches are then submitted to the data structure of draws to be handled in the motion vector pass, alongside the 1:1 matches that were added in the original hash matching step.

Once all of the draw matches are complete, matching pairs are submitted as new draws to a new render pass. This render pass uses the same shader for all draws. Each draw takes its current and previous positions chosen by the draw-call matching algorithm as vertex buffer inputs. Notably, draw calls are combined if their XFB offsets are consecutive in the original buffers, even going so far as to make the entire MV pass a single draw for a completely static scene.

The vertex shader for these draws dictates where the MV is rendered; whether it is rendered at the previous position of the object, the future position of the object, or somewhere in-between. Which of these is best depends on the problem expected to be solved with the MVs, but for the simple case of gap-filling and interpolation (GFI), the algorithm outputs the MVs at the position half-way between the previous and current position, since that is where the interpolated frame will sample from. During rasterization, the previous and current positions are interpolated between the vertices onto each fragment to calculate per-fragment MVs.

The fragment shader then outputs the actual MV, which in the case of GFI points backwards to the original position to sample from:

$$fragColor = 0.5 * ( prev\_position - current\_position )$$

This can be modified trivially to point forwards instead of backwards by swapping the vector direction to be previous to current. However, for most efficient rendering algorithms it is most beneficial to be able to look back into the contents of the previous frame that represents the same object's previously rendered result.

Depending on the use-case of MVs, it is likely beneficial to also include knowledge of which areas of the MV image point to information that was not actually available in the previous frame's image. For example, when part of an object was occluded in frame N−1, but becomes visible in frame N, the MV map will naturally point to the occluder, not the occluded, which is not desirable when the intention is to access the occluded (non-visible object)'s colour.

According to an example, this can be detected by checking the previous XFB z-position against the previous frame's depth map at MV render time. If the depth map value at the previous XFB x,y position is equal to the previous XFB z-position, the object rendered last frame at that position was this object. However, if the previous depth map value at the previous XFB x,y position is closer than the previous XFB z-position, the object rendered last frame at that position was not this object, it was another object that occluded this object. Therefore, this can be notated in the MV map. This can be done by, e.g., adding an impossibly large value in the MV map for areas where this occurred. If the opposite is true and the depth map value is further than the previous XFB position, then this object was discarded during fragment rendering, which is also useful information. For the case of GFI, this information can be used to also discard these fragments in the MV render.

According to an example, the motion vector pass has a special case for handling when objects change level of detail (LOD). When LOD changes occur, the draw-call matching will fail for a single frame as there is no match between the object in the previous LOD and the object in the new LOD. In an example, any draws that were present in frame N but not present in frame N+1 can be submitted into a special motion vector draw. These special draws can render at the old position with a motion vector value of zero.

The motion of the object will not be currently considered when the LOD change re-render takes place, so the object can stutter back very slightly for the frame that the LOD is changed. However, this guarantees that the old object will be rendered during the LOD transition, making the transition much more seamless and avoiding flickers of large missing regions where the object should be.

According to an example, a generated MV can be used to generate an intermediate frame. For example, a full-screen pass can be run, where each pixel samples the MV image at its own location. The MV value sampled is used to determine where in the existing rendered frame to look for the colour value to offset to the current pixel. This is an extremely cheap operation, essentially just a single texture sample per pixel. If the MV value is marked as invalid, that invalidity can be propagated into the interpolated image. Intermediate frame generation comes in two forms: interpolation (GFI) and extrapolation (GFE). For GFI: Interpolation refers to the blending of two existing frames, the previous and current. The interpolated frame is then inserted for display in the middle. When performing interpolation, access to two fully rendered frames is provided, the previous frame and the current frame. This means that there is access to all colour data that could be useful for the interpolated frame, since any previously occluded regions can be filled with colour from the current frame, and everything else can be filled from the previous frame. However, GFI has the disadvantage of adding additional latency to the application. The intermediate frame cannot be generated until both the previous and current frames are fully rendered. Therefore, rendering of the intermediate frame must wait until the current frame is finished, only then can generation and eventually presentation of the intermediate frame occur. Finally, the current frame is displayed.

GFE: Extrapolation refers to the generation of a new frame immediately after the current frame is rendered, without waiting for another frame to interpolate between. Therefore, extrapolation can take a single rendered frame as input, projecting it into the future to generate a new frame ahead of time.

According to an example, motion vectors for extrapolation can be generated in either one of two ways. One is to use the motion vectors generated between N−1 and N to predict future motion in, e.g., N+0.5. This works well enough for the majority of cases, but can have issues with sudden, drastic changes in motion, where the algorithm will over-predict the motion of objects. The alternative is to gather some information early on from frame N+1, before N+1 has processed its rendering tasks. Preferably this does only the work required to generate transformed vertex positions, then generates and displays the intermediate frame, before finally continuing on to render and display of frame N+1. This has the benefit of guaranteeing correct motion, but adds additional computational work.

The primary upside of extrapolation is that latency is significantly lower than interpolation. Display of frames is never delayed as in interpolation, and frames can even seem like they come faster as the intermediate frame is immediately extrapolated after frame N is displayed.

For missing regions in an interpolated frame where pixels are either at the edge of the screen, where new geometry is entering the scene, or at the trailing edge of objects in motion, where geometry is coming out from occlusion in the previous frame, the missing regions can, in an example, be filled in with data from frame N+1.

In the case of extrapolation, there is no access to such data, as no future frames have been rendered yet. Therefore, some new data can be generated to fill those missing regions. For example, nearby screen-space information can be used to infill missing regions. In an example, an iterative infilling approach can be used, filling in from the outside of the missing region into the centre, propagating information as it goes. To maintain hard lines at geometry edges, infill can be depth aware. That is, which direction to infill from can be determined based on pixel depth within the region. Accordingly, only the current pixel will be filled with a combination of neighbour's colour values that have a very similar depth. The depth can be sampled from a depth map generated during the motion vector pass. This prevents an object in the background being blended with the edges of an object in the foreground.

According to an example, the approach described above for MV generation can be implemented at a GPU-driver level in a device. This is beneficial for the developer of the application, as the application will have the potential to make use of efficient rendering techniques that will increase performance without any additional development cost. This is also beneficial for the device, which will give the user a better, smoother experience without additional power costs. Notably, the device also has an exact idea of the format, generation method and usage of the motion vectors generated, therefore optimizations could be made to the hardware to further improve the efficiency of the algorithm.

Furthermore, the approach is completely application agnostic. Once implemented on a device, the transformed vertices can be gathered in any application running on the device. This is extremely efficient in terms of development cost, with only minimal QA required to make sure the render pipeline used within a new application is compatible before usage.

Although described here in relation to usage for frame interpolation, motion vectors have a variety of usages. Motion vectors generated as described herein can be used for other efficient rendering techniques such as VRS and Super-Sampling, or even in more stylistic algorithms such as motion blur. In all cases, it is beneficial for the MVs to be pointing backward, in the direction the object is coming from.

Almost no extra GPU work aside from the MV pass itself is required. This pass performs very little actual GPU work in the shaders, and the CPU cost of the pass is diminished with optimizations such as draw-call merging. The CPU cost of the algorithm mostly comes from draw-call matching, particularly on distance matching for draw calls with large numbers of instances.

According to an example, vertices may be gathered in an alternative fashion. Graphics APIs may be modified to include a concept of “Object ID”. The ID can be tied to the concept of a game engine's game object. This would remove the requirement for draw-call matching, nullifying the vast majority of the CPU cost of the motion vector generation. Similarly, alternative methods of draw-call matching could be used, including more complex distance-matching algorithms, or AI-based approaches for example. MVs can be generated using “Optical Flow”. That is, using a computer vision block matching or AI process to generate a motion flow field, taking only two rendered images as input.

Examples in the present disclosure can be provided as procedures, methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show an order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a machine such as a wearable device, a general-purpose computer, a platform comprising user equipment such as a smart device, e.g., a smart phone, a special purpose computer, an embedded processor or processors of other programmable data processing devices to realize the functions described in the description and diagrams. In particular, a processor or processing apparatus may execute the machine-readable instructions. Thus, modules of apparatus (e.g., a module to generate MVs) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a mode. For example, the instructions may be provided on a non-transitory computer readable storage medium encoded with instructions, executable by a processor.

Further, the teachings herein may be implemented in the form of a computer or software product, such as a non-transitory machine-readable storage medium, the computer software or product being stored in a storage medium and comprising a plurality of instructions, e.g., machine readable instructions, for making a computer device implement the methods recited in the examples of the present disclosure.

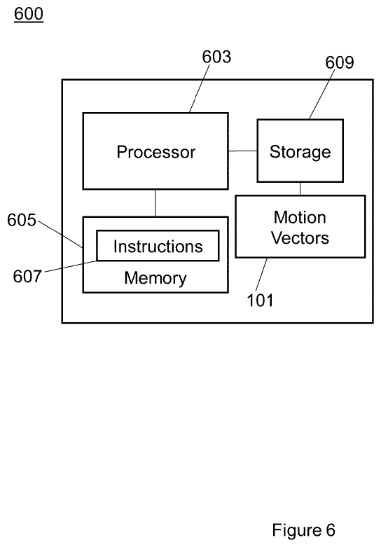

FIG. 6 is a schematic representation of a machine according to an example. The machine (or apparatus) of FIG. 6 can be implemented as part of a device as described above with reference to FIGS. 1 to 5, for example. The machine 600 comprises a processor 603, and a memory 605 to store instructions 607, executable by the processor 603. The machine comprises a storage 609 that can be used to store data representing, e.g., MVs, distance measures and so on, as described above. The instructions 607, executable by the processor 603, can cause the machine 600 to generate a first vertex output representing a vertex stream comprising a first list of vertices for opaque objects of a first frame of the scene, wherein the first list of vertices for opaque objects of the first frame of the scene is arranged according to an order of drawing commands submitted in respect of the opaque objects of the first frame of the scene, generate a first set of hash values using data associated with the first list of vertices for opaque objects of the first frame of the scene, generate a second vertex output representing a vertex stream comprising a second list of vertices for opaque objects of a second frame of the scene, wherein the second frame of the scene is adjacent to the first frame of the scene, and wherein the second list of vertices for opaque objects of the second frame of the scene is arranged according to an order of drawing commands submitted in respect of the opaque objects of the second frame of the scene, generate a second set of hash values using data associated with the second list of vertices for opaque objects of the second frame of the scene, match opaque objects of the first frame of the scene with opaque objects of the second frame of the scene using the first set of hash values and the second set of hash values, whereby to determine transformed vertex outputs representing corresponding objects from the first frame of the scene and the second frame of the scene, and execute a render operation using the transformed vertex outputs, whereby to generate a set of motion vectors for the scene representing a transformation between the geometry of the opaque objects of the first frame of the scene and the geometry of the opaque objects of the second frame of the scene.

Accordingly, the machine 600 can implement a method for generating a set of motion vectors representing a transformation in geometry in a scene to be rendered by the apparatus 600.

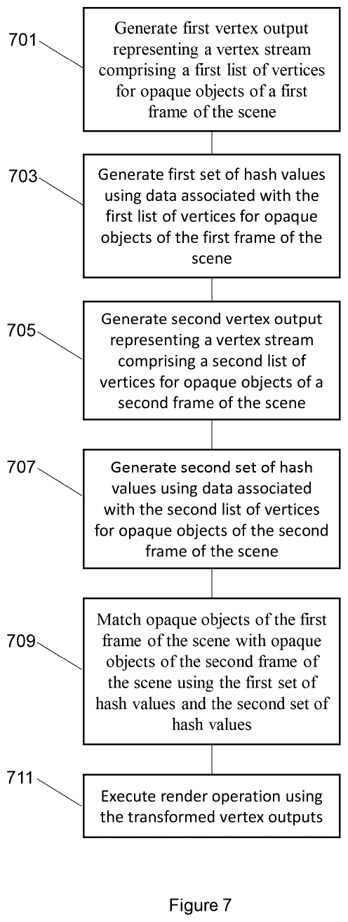

FIG. 7 is a schematic representation of a flow chart for a method according to an example. In the example of FIG. 7, a method for generating a set of motion vectors representing a transformation in geometry in a scene to be rendered is provided. In block 701 a first vertex output representing a vertex stream comprising a first list of vertices for opaque objects of a first frame of the scene is generated, wherein the first list of vertices for opaque objects of the first frame of the scene is arranged according to an order of drawing commands submitted in respect of the opaque objects of the first frame of the scene.

In block 703, a first set of hash values using data associated with the first list of vertices for opaque objects of the first frame of the scene are generated.

In block 705, a second vertex output representing a vertex stream comprising a second list of vertices for opaque objects of a second frame of the scene is generated, wherein the second frame of the scene is adjacent to the first frame of the scene, and wherein the second list of vertices for opaque objects of the second frame of the scene is arranged according to an order of drawing commands submitted in respect of the opaque objects of the second frame of the scene.

In block 707, a second set of hash values using data associated with the second list of vertices for opaque objects of the second frame of the scene is generated.

In block 709, opaque objects of the first frame of the scene are matched with opaque objects of the second frame of the scene using the first set of hash values and the second set of hash values, whereby to determine transformed vertex outputs representing corresponding objects from the first frame of the scene and the second frame of the scene.

In block 711, a render operation is executed using the transformed vertex outputs, whereby to generate a set of motion vectors for the scene representing a transformation in the geometry of the opaque objects of the first frame of the scene with the geometry of the opaque objects of the second frame of the scene.

In some examples, some methods can be performed in a cloud-computing or network-based environment. Cloud-computing environments may provide various services and applications via the Internet. These cloud-based services (e.g., software as a service, platform as a service, infrastructure as a service, etc.) may be accessible through a web browser or other remote interface of the user equipment for example. Various functions described herein may be provided through a remote desktop environment or any other cloud-based computing environment.

While various embodiments have been described and/or illustrated herein in the context of fully functional computing systems, one or more of these embodiments may be distributed as a program product in a variety of forms, regardless of the particular type of computer-readable-storage media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the embodiments disclosed herein. In addition, one or more of the modules described herein may transform data, physical devices, and/or representations of physical devices from one form to another.

The preceding description has been provided to enable others skilled in the art to best utilize various aspects of the embodiments disclosed herein. This description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

What is claimed is:

1. An apparatus for generating a set of motion vectors representing a transformation in geometry in a scene to be rendered by the apparatus, the apparatus comprising:
a processor;
a memory coupled to the processor, wherein the memory is configured to store program code executable by the processor, the program code comprises one or more instructions, which upon being executed by the processor, cause the apparatus to:
generate a first vertex output representing a vertex stream comprising a first list of vertices for opaque objects of a first frame of the scene, wherein the first list of vertices for opaque objects of the first frame of the scene is arranged according to an order of drawing commands submitted in respect of the opaque objects of the first frame of the scene;
generate a first set of hash values using data associated with the first list of vertices for opaque objects of the first frame of the scene;
generate a second vertex output representing a vertex stream comprising a second list of vertices for opaque objects of a second frame of the scene, wherein the second frame of the scene is adjacent to the first frame of the scene, and wherein the second list of vertices for opaque objects of the second frame of the scene is arranged according to an order of drawing commands submitted in respect of the opaque objects of the second frame of the scene;
generate a second set of hash values using data associated with the second list of vertices for opaque objects of the second frame of the scene;
match opaque objects of the first frame of the scene with opaque objects of the second frame of the scene using the first set of hash values and the second set of hash values, to determine transformed vertex outputs representing corresponding objects from the first frame of the scene and the second frame of the scene; and
execute a render operation using the transformed vertex outputs, to generate a set of motion vectors for the scene representing a transformation between the geometry of the opaque objects of the first frame of the scene and the geometry of the opaque objects of the second frame of the scene.

2. The apparatus as claimed in claim 1, wherein the one or more instructions, upon being executed by the processor, cause the apparatus to:
determine a set of identical hash values occurring between the first set of hash values and the second set of hash values; and
for each opaque object represented by one of the hash values in the set of identical hash values, minimise a measure of total geometric distance between estimated projections for vertices of an opaque object from each of the first frame of the scene and the second frame of the scene and actual projections for vertices of the opaque object from each of the first frame of the scene and the second frame of the scene.

3. The apparatus as claimed in claim 1, wherein the one or more instructions, upon being executed by the processor, cause the apparatus to:
execute a render operation using the transformed vertex outputs by executing a draw call for objects from the first frame of the scene and the second frame of the scene.

4. The apparatus as claimed in claim 1, wherein the one or more instructions, upon being executed by the processor, cause the apparatus to:
enable a transform feedback buffer to store a post-transformation rendering state for an opaque object, wherein a post-transformation rendering state for an opaque object of the first frame of the scene comprises the first list of vertices, and wherein a post-transformation rendering state for an opaque object of the second frame of the scene comprises the second list of vertices.

5. The apparatus as claimed in claim 1, wherein the one or more instructions, upon being executed by the processor, cause the apparatus to:
use the set of motion vectors for the scene to interpolate and/or extrapolate vertex information for one or more opaque objects of the scene, to generate a third frame of the scene comprising a frame intermediate to the first frame of the scene and the second frame of the scene and/or a frame before and/or after the first frame of the scene and/or the second frame of the screen.

6. A non-transitory machine-readable storage medium encoded with processor-executable instructions, for generating a set of motion vectors representing a transformation in geometry in a scene to be rendered by an apparatus, wherein the instructions, upon being executed by a processor, cause the processor to:
generate a first vertex output representing a vertex stream comprising a first list of vertices for opaque objects of a first frame of the scene, wherein the first list of vertices for opaque objects of the first frame of the scene is arranged according to an order of drawing commands submitted in respect of the opaque objects of the first frame of the scene;
generate a first set of hash values using data associated with the first list of vertices for opaque objects of the first frame of the scene;
generate a second vertex output representing a vertex stream comprising a second list of vertices for opaque objects of a second frame of the scene, wherein the second frame of the scene is adjacent to the first frame of the scene, and wherein the second list of vertices for opaque objects of the second frame of the scene is arranged according to an order of drawing commands submitted in respect of the opaque objects of the second frame of the scene;
generate a second set of hash values using data associated with the second list of vertices for opaque objects of the second frame of the scene;
match opaque objects of the first frame of the scene with opaque objects of the second frame of the scene using the first set of hash values and the second set of hash values, to determine transformed vertex outputs representing corresponding objects from the first frame of the scene and the second frame of the scene; and
execute a render operation using the transformed vertex outputs, to generate a set of motion vectors for the scene representing a transformation in the geometry of the opaque objects of the first frame of the scene with the geometry of the opaque objects of the second frame of the scene.

7. The non-transitory machine-readable storage medium as claimed in claim 6, wherein the instructions, upon being executed by the processor, further cause the processor to:
determine a set of identical hash values occurring between the first set of hash values and the second set of hash values; and
for each opaque object represented by one of the hash values in the set of identical hash values, minimise a measure of total geometric distance between estimated projections for vertices of the opaque object from each of the first frame of the scene and the second frame of the scene, and actual projections for vertices of the opaque object from each of the first frame of the scene and the second frame of the scene.

8. The non-transitory machine-readable storage medium as claimed in claim 6, wherein the instructions, upon being executed by the processor, further cause the processor to:
execute a render operation using the transformed vertex outputs by executing a draw call for objects from the first frame of the scene and the second frame of the scene.

9. The non-transitory machine-readable storage medium as claimed in claim 6, wherein the instructions, upon being executed by the processor, further cause the processor to:
enable a transform feedback buffer to store a post-transformation rendering state for an opaque object, wherein a post-transformation rendering state for an opaque object of the first frame of the scene comprises the first list of vertices, and wherein a post-transformation rendering state for an opaque object of the second frame of the scene comprises the second list of vertices.

10. The non-transitory machine-readable storage medium as claimed in claim 6, wherein the instructions, upon being executed by the processor, further cause the processor to:
use the set of motion vectors for the scene to interpolate and/or extrapolate vertex information for one or more opaque objects of the scene, to generate a third frame of the scene comprising a frame intermediate to the first frame of the scene and the second frame of the scene and/or a frame before and/or after the first frame of the scene and/or the second frame of the screen.

11. A method for generating a set of motion vectors representing a transformation in geometry in a scene to be rendered by an apparatus for generating the set of motion vectors, the method comprising:
generating a first vertex output representing a vertex stream comprising a first list of vertices for opaque objects of a first frame of the scene, wherein the first list of vertices for opaque objects of the first frame of the scene is arranged according to an order of drawing commands submitted in respect of the opaque objects of the first frame of the scene;
generating a first set of hash values using data associated with the first list of vertices for opaque objects of the first frame of the scene;
generating a second vertex output representing a vertex stream comprising a second list of vertices for opaque objects of a second frame of the scene, wherein the second frame of the scene is adjacent to the first frame of the scene, and wherein the second list of vertices for opaque objects of the second frame of the scene is arranged according to an order of drawing commands submitted in respect of the opaque objects of the second frame of the scene;
generating a second set of hash values using data associated with the second list of vertices for opaque objects of the second frame of the scene;
matching opaque objects of the first frame of the scene with opaque objects of the second frame of the scene using the first set of hash values and the second set of hash values, to determine transformed vertex outputs representing corresponding objects from the first frame of the scene and the second frame of the scene; and
executing a render operation using the transformed vertex outputs, to generate a set of motion vectors for the scene representing a transformation in the geometry of the opaque objects of the first frame of the scene with the geometry of the opaque objects of the second frame of the scene.

12. The method as claimed in claim 11, further comprising:
determining a set of identical hash values occurring between the first set of hash values and the second set of hash values; and
for each opaque object represented by one of the hash values in the set of identical hash values, minimising a measure of total geometric distance between estimated projections for vertices of the opaque object from each of the first frame of the scene and the second frame of the scene, and actual projections for vertices of the opaque object from each of the first frame of the scene and the second frame of the scene.

13. The method as claimed in claim 11, further comprising:
executing a render operation using the transformed vertex outputs by executing a draw call for objects from the first frame of the scene and the second frame of the scene.

14. The method as claimed in claim 11, further comprising:
enabling a transform feedback buffer to store a post-transformation rendering state for an opaque object, wherein a post-transformation rendering state for an opaque object of the first frame of the scene comprises the first list of vertices, and wherein a post-transformation rendering state for an opaque object of the second frame of the scene comprises the second list of vertices.

15. The method as claimed in claim 11, further comprising:
using the set of motion vectors for the scene, interpolating and/or extrapolating vertex information for one or more opaque objects of the scene, to generate a third frame of the scene comprising a frame intermediate to the first frame of the scene and the second frame of the scene and/or a frame before and/or after the first frame of the scene and/or the second frame of the screen.
